(19) United States
(12) Patent Application Publication
(10) Pub. No.: US 2001/0027910 A1
(43) Pub. Date: Oct. 11, 2001

(54) Lane arrangement

(76) Inventors: Johnny J. Hunter, Woodstock, GA (US); Will L. Culpepper, Covington, GA (US)

Correspondence Address: Michael V. Drew, The Mead Corporation, 4850D North Church Lane, Smyrna, GA, 30080, US

(21) Appl. No.: 09/838,501

(22) Filed: Apr. 19, 2001

Related U.S. Application Data
(63) Continuation of application No. PCT/US99/24538, filed on Oct. 20, 1999.

(51) Int. Cl. B65G 15/00

(52) U.S. Cl. 198/836.1

(57) ABSTRACT

A lane arrangement has pairs of elongated partitions joined in parallel side-by-side disposition by adjustable fasteners to form lanes of adjustable width. The lanes so formed are in turn joined to one another by additional adjustable fasteners to form additional lanes interposed between the first set of lanes.

This is a continuation of international application No. PCT/US99/24538, filed Oct. 20, 1999, which is pending at the time of filing hereof, and which international application claims priority based upon U.S. patent application Ser. No. 09/175,599, filed Oct. 20, 1998, now abandoned.

This invention relates to continuous-motion cartoning machines and, more particularly, to an adjustable article lane arrangement for such machines.

Continuous-motion cartoning machines (also known as “packaging machines”) are useful for packaging multiple articles such as beverage cans in cartons or other packaging components. An example of a continuous-motion cartoning machine is shown in U.S. Pat. No. 5,241,806 to Ziegler et al.

Articles, such as cans or bottles, are often translated along a packaging machine in lanes. Lane spacing corresponds to the diameter or other widthwise dimension of the article to be packaged. It is important to maintain predetermined lane spacing in a packaging machine for optimum performance. Thus, it can be appreciated that it would be useful to have a means for adjusting and maintaining the spacing of lanes in a packaging machine. It can be further appreciated that it would be useful to have a means for adjusting and maintaining the spacing of an individual lane of a multiple-lane arrangement without disturbing the widths of other lanes interconnected therewith.

### BRIEF SUMMARY OF THE INVENTION

A lane arrangement according to a preferred embodiment of the invention has pairs of elongated partitions joined in parallel side-by-side disposition by adjustable fasteners to form lanes of adjustable width. The lanes so formed are in turn joined to one another by additional adjustable fasteners to form additional lanes interposed between the first set of lanes.

Other advantages and objects of the present invention will be apparent from the following description, the accompanying drawings, and the appended claims.

### BRIEF DESCRIPTION OF THE DRAWINGS

FIG. 1 is an isometric illustration of a continuous-motion cartoning machine which incorporates a lane arrangement, in accordance with a preferred embodiment of the invention.

FIG. 2 is an isolated isometric illustration of the lange arrangement of the machine of FIG. 1.

FIG. 3 is a plan view of a portion of the lane arrangement of FIG. 2.

### DETAILED DESCRIPTION OF THE INVENTION

Throughout the drawings the same reference numerals are used to denote the same or like features of the invention.

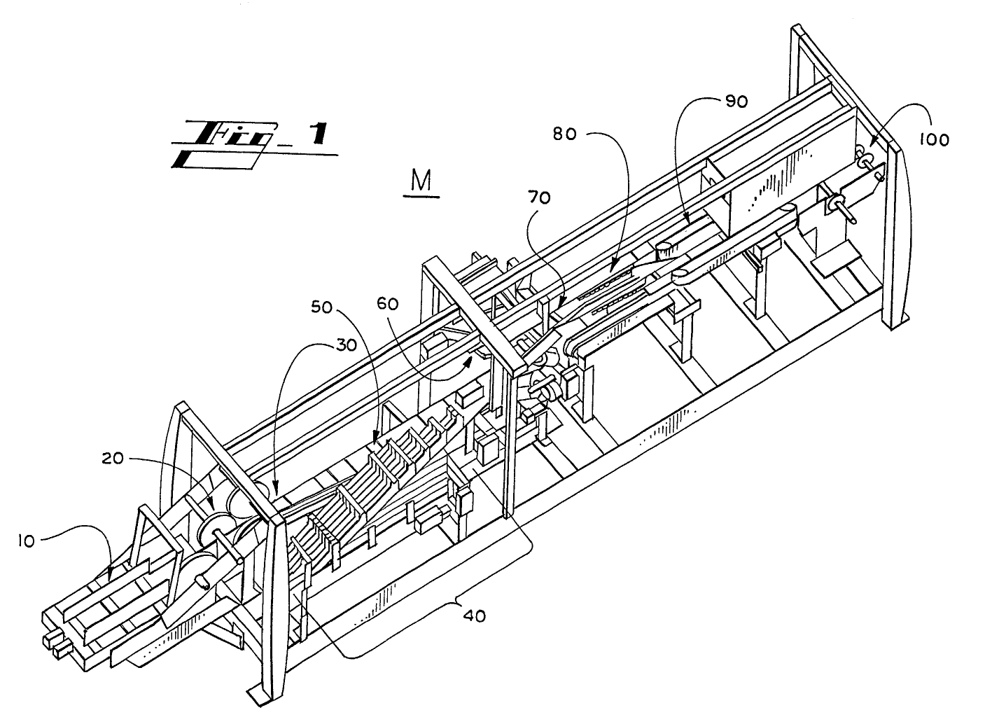

Referring first to FIG. 1, therein is illustrated in the context of a continuous-motion cartoning machine M, an adjustable carton feeder 20, in accordance with a preferred embodiment of the invention. In the machine, the carton hopper 10 receives collapsed cartons C stacked in substantially upright condition as shown. Cartons C are withdrawn from the carton hopper 10 by the adjustable carton feeder 20 and then deposited in substantially erect condition at the beginning of the carton conveyor 30. As cartons are continuously engaged and translated through the machine M, articles, such as beverage cans, to be packaged in the cartons C are also translated through the machine in synchronous motion with the cartons. An article conveyor 40 and article lane arrangement 50 form an article transport that urges the articles into the cartons C. Article-engaging wheels 60 complete the process of placement of the articles into cartons C. Side-flap folding wheels 70 (partially obstructed in FIG. 1) engage and inwardly fold the side flaps of cartons having side flaps. Glue is applied to the cartons C at a gluing station 80. At a sealing station 90, end flaps of the cartons C are pressed and held into contact with glue that has been previously applied. Packaged, sealed cartons are ejected from the machine at the ejection station 100.

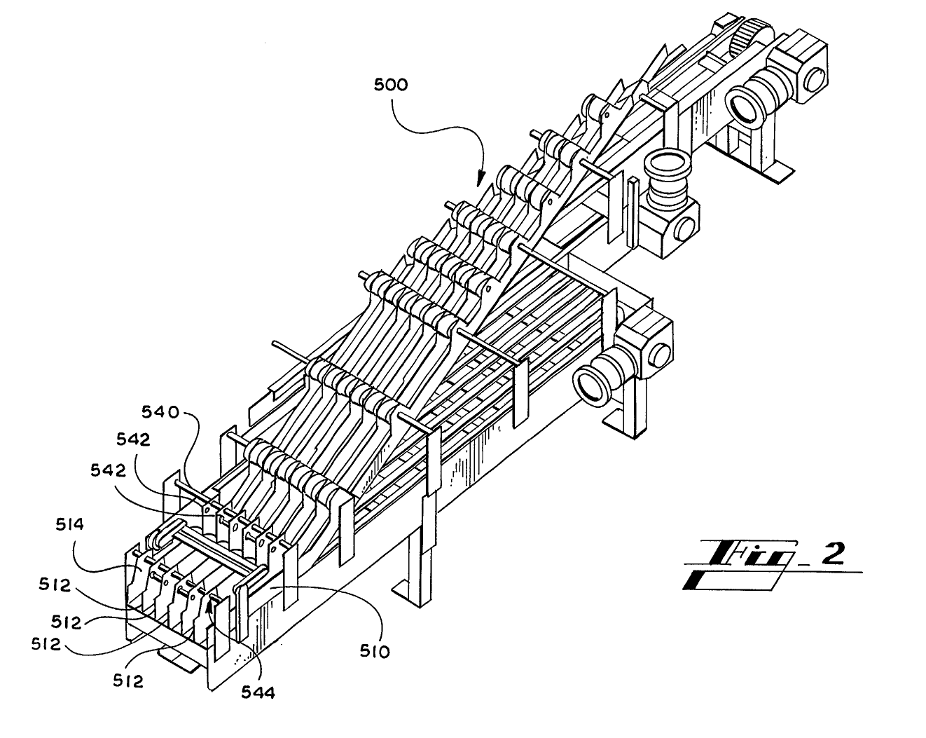

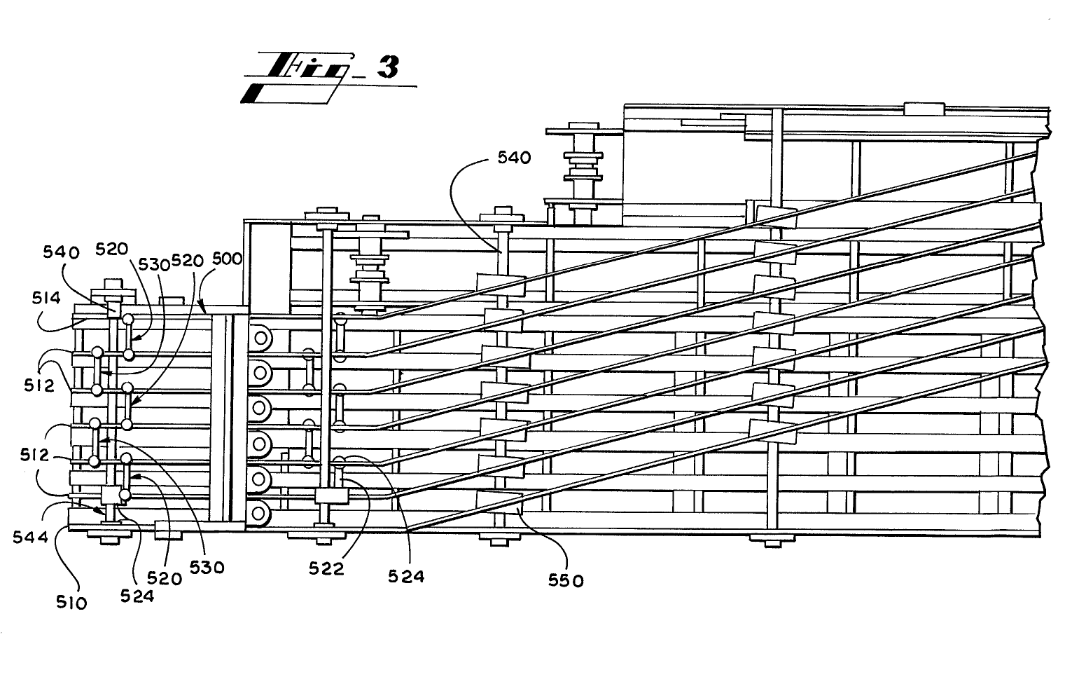

Reference is now made to FIG. 2 and FIG. 3 simultaneously. Pairs of elongated partitions 510, 512, 514 are fastened together in spaced-apart, parallel disposition with respect to one another by adjustable fasteners 520, 530. The adjustable fasteners 520, 530 are adjustable in that the width between connected partitions 510, 512, 514 can be varied by adjusting the engaging element between the fasteners 520, 530 and the partitions 510, 512, 514. The outermost partitions 510, 514 have been referenced by numerals 510, 514 which are distinct from the numeral 512 which references the interiorly disposed partitions 512 for convenience of discussion. Each interior partition 512 is connected to another partition 510, 512 or 514 on either side thereof by a respective pair of fasteners 520, 530. Stated differently for convenience of understanding, a first set of lanes may be considered to be formed by pairs of partitions 510, 512, 514 connected by a first set of fasteners 520 or 530. The designation of a set of lanes and/or fasteners as the “first” set is for convenience of reference only. Each of the lanes which is considered to be a first lane created by partitions connected to a first fastener 520 is in turn connected to another first lane by what for convenience are designated second fasteners 530. The resulting arrangement of interconnected partitions 510, 512, 514 by fasteners is the same under each above description. It is to be noted that the fasteners 520, 530 can be, and, in the preferred embodiment disclosed hereby, are identical and interchangeable. The set of lanes and fasteners 520 referred to above as the first set may be considered the second set without departing from the teachings of the invention.

The fasteners 520, 530 may take any form which is capable of attaching the partitions in parallel, spaced-apart relationship to one another. A suitable fastener 520, 530 illustrated in the preferred embodiment includes a member 522 which is threaded at each end. A nut 524 is screwed onto the threaded portion on both sides of each partition 510, 512, 514. The width of each lane (that is, the distance between the two partitions fastened by a single fastener 520, 530) is adjusted by moving the pair of nuts 524 which sandwich and, thereby engage, each partition 510, 512, 514 inward or outward with respect to the center of the member 522.

In operation, when the width of a single lane is adjusted as described above the manner in which the partitions are interconnected causes the widths of other lanes to remain unaffected.

For additional stability, the partitions 510, 512, 514 (and lanes formed thereby) are slidably mounted a support member 540. In the preferred embodiment illustrated, the partitions are mounted upon the support member 540 by means of apertures 542 through which the support member 540 extends. The lanes (partitions 510, 512, 514 and fasteners 520, 530) are vertically supported by their dependence from the support member 540. The lanes are restrained from horizontal movement by affixation of one of the diametrically opposite endmost partitions 510, 514 to the support member 540. In the preferred embodiment illustrated, outermost partition 510 is connected to a threaded end of the support member 540 by nuts. The support member 540 is in turn connected to a stabilizing element such as a machine frame.

It is to be noted that a portion 544 of the support member 540 may serve as a fastener for the outermost lane wherein the outermost partition 510 is attached to and spaced apart from an adjacent portion 512 by the support member 540. The fastener portion 544 employs nuts 524 on a threaded portion of the support member 540 to sandwich the partitions 510, 512.

When the lanes (and partitions 510, 512, 514) are disposed at an angle in relation to the support member 540, wedges 550 are used as compensators so that alignment and adjustability are maintained. The compensating wedges 550 enable the partitions 510, 512, 514 to be sandwiched in parallel disposition with respect to one another but at an angle to the support member 540 while each lane width remains individually adjustable. Modifications may be made in the foregoing without departing from the scope and spirit of the claimed invention.

What is claimed is:

1. A lane arrangement comprising:
a plurality of elongated partitions;
a plurality of first adjustable fasteners interconnecting respective pairs of said plurality of elongated partitions in parallel disposition with one another so as to form first lanes having adjustable widths; and
a plurality of second adjustable fasteners interconnecting said elongated partitions of respective ones of said first lanes so as to form a plurality of second lanes between pairs of said first lanes having adjustable widths;
wherein when one of said first or second adjustable fasteners is adjusted so as to modify said width of a respective said first lane or said second lane, widths of other ones of said first lanes as said second lanes are maintained.

2. The lane arrangement of claim 1, further comprising at least one support member transversely extending through said elongated partitions having one of distal ones of said partitions fixedly connected thereto.

3. The lane arrangement of claim 1, wherein said plurality of elongated partitions are disposed in angular relation with respect to said support member and compensating members are interposed between each of said plurality of elongated partitions and said fastener.

4. The lane arrangement of claim 1, said compensating members comprising wedges.
